(19) United States
(12) Patent Application Publication
(10) Pub. No.: US 2009/0196167 A1
(43) Pub. Date: Aug. 6, 2009

(54) Method and Apparatus for Improving Reset Mechanism of Radio Link Re-establishment Timers in a Wireless Communications System

(76) Inventor: Ming-Der Hu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/206,756

(22) Filed: Sep. 9, 2008

(30) Foreign Application Priority Data
Jan. 31, 2008 (TW) 097103695

(51) Int. Cl. G06F 11/07

(52) U.S. Cl. 370/216

(57) ABSTRACT

In order to avoid system malfunctions, the present invention discloses a method of improving the reset mechanism of radio link re-establishment timers for a user equipment in a wireless communications system. The method includes performing a cell update procedure according to a radio link failure event, stopping a plurality of re-establishment timers after responding to a CELL UPDATE CONFIRM message, and clearing a variable including the expiration states of the plurality of re-establishment timers.

### BACKGROUND OF THE INVENTION

1. Field of the Invention

The present invention relates to a method and related apparatus for improving reset mechanism of radio link re-establishment timers in a wireless communications system, and more particularly, to a method and related apparatus for preventing unpredictable malfunctions or receiving an incorrect CELL UPDATE CONFIRM message for a user equipment in a wireless communications system for enhancing transmission efficiency.

2. Description of the Prior Art

The third generation (3G) mobile telecommunications system, the Universal Mobile Telecommunications System (UMTS), has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of quality of service (QoS) requirements simultaneously, providing diverse, flexible, two-way transmission services and better communication quality to reduce transmission interruption rates. Through the 3G mobile telecommunications system, a user can utilize a wireless communications device, such as a mobile phone, to realize real-time video communications, conference calls, real-time games, online music broadcasts, and email sending/receiving. However, these functions rely on fast, instantaneous transmission. Thus, targeting the third generation mobile telecommunication technology, the prior art provides High Speed Package Access (HSPA) technology, which includes High Speed Downlink Package Access (HSDPA) and High Speed Uplink Package Access (HSUPA), to increase bandwidth utility rate and package data processing efficiency to improve the uplink/downlink transmission rate.

According to the related protocol specifications, one of protocol stacks of the UMTS, access stratum (AS), can be segmented into sub-layers for different functions. The operations of the sub-layers in the AS are well known in the art, and detailed description is not given here. The Radio Resource Control (RRC) layer, a Layer 3 protocol, is the core of communications protocols related to AS and is located in radio network controllers (RNC) of the UMTS Terrestrial Radio Access Network (UTRAN) and a user equipment (UE). The RRC layer uses RRC messages to perform RRC procedures. RRC messages are formed from many Information Elements (IE) used for embedding necessary information for setting, changing, or releasing protocol entities of Layer 2 and Layer 1, thereby establishing, adjusting, or canceling information exchange channels to perform data packet transportation. In the RRC layer, all logical data communication exchange channels for providing data transmission exchanges and control signal transmission exchanges, are defined in the context of a Radio Bearer (RB).

The RRC layer defines various RRC modes/states to describe the usage of radio resource for the UE. RRC modes can be divided into idle mode and RRC connected mode according to whether the RRC connection is established. RRC connected mode are further divided into CELL_DCH state, CELL_FACH state, CELL_PCH state and URA_PCH state.

On the other hand, the RRC layer defines many timers in order to handle specific conditions of the radio resource control for the UE. For example, when the criteria for radio link failure are fulfilled, a timer T314 or T315 will be started according to radio access bearer(s) associated. Meanwhile, the UE performs one of the RRC procedures, a cell update procedure with cause “Radio link failure”.

The actions of the timers T314 and T315 in the cell update procedure are described as follows. When the radio link failure is fulfilled, the timer T314 is started if the stored value of the timer T314 is greater than zero and radio bearers associated with the timer T314 exist, or if the stored value of the timer T314 is greater than zero and only RRC connection exists. The timer T314 is stopped when the cell update procedure has been completed. Similarly, timer T315 is started only if radio bearer(s) that are associated with T315 exist and stopped when the cell update procedure has been completed.

According to RRC specification, the UE sends a CELL UPDATE message to the UTRAN for starting the cell update procedure when the radio link failure occurs. When initiating the cell update procedure, the UE shall:

1. Stop timer T305.

2. If the UE is in the CEL_DCH state, set an IE “T314 expired” and an IE “T315 expired” in a variable RB_TIMER_INDICATOR to FALSE.

The IE “T314 expired” and the IE “T315 expired” indicators respectively represent the expiration states of the timer T314 and the timer T315. When the timer T314 has elapsed, the IE “T314 expired” is set to TRUE for the timer T314 expired; the IE “T314 expired” is set to FALSE for the timer T314 is still running. The IE “T315 expired” also works in the same way.

The IE “T314 expired” and the IE “T315 expired” are included in an IE “RB timer indicator” in the CELL UPDATE message. In other words, the UTRAN can identify the IE “T314 expired” and the IE “T315 expired” status via the CELL UPDATE message received from the UE.

If the timer T314 is expired while initiating the cell update procedure, the UE shall:

1. Release all radio bearers associated with any radio access bearers for which in the variable ESTABLISHED_RABS the value of an IE “Re-establishment timer” is set to “use T314”.

2. In the variable RB_TIMER_INDICATOR set the IE “T314 expired” to TRUE.

Similarly, if the timer T315 is expired while initiating the cell update procedure, the UE shall do the same as the above. Note that, the variable ESTABLISHED_RABS is used to store information about the established radio access bearers and signaling radio bearers in the UE.

After the RNC of UTRAN confirms the cell update procedure, the UE receives a CELL UPDATE CONFIRM message from the UTRAN and performs associated actions accordingly. The last action for the UE is: Stopping the timer T314 and/or the timer T315 if they are still running.

From the above, when the timer T314/T315 is started and the timer T314/T315 has elapsed, the IE “T314 expired”/“T315 expired” is set to TRUE. Note that, if the timer T314/T315 is still running after the UE responds to the CELL UPDATE CONFIRM message, the UE just stops the timer T314/T315 without clearing the contents of the IE “T314 expired”/“T315 expired” in variable RB_TIMER_INDICATOR.

When the UE leaves UTRA RRC connected mode, i.e., enters idle mode, the variable RB_TIMER_INDICATOR will be cleared. Note that, if the IE “T314 expired”/“T315 expired” is set to TRUE, there are only two ways to clear the variable RB_TIMER_INDICATOR as follows:

1. The variable RB_TIMER_INDICATOR is cleared when initiating the cell update procedure in CELL_DCH state.

2. The variable RB_TIMER_INDICATOR is cleared when the UE enters the idle mode.

In the 3G mobile telecommunications system, circuit-switching service is much more used than packet-switching service. In this situation, if the UE ends up a voice call and has no need for packet-switching service for a while, the UE shall enter idle mode and clear the variable RB_TIMER_INDICATOR. However, for the growing demands for mass data transmission and internet access, the UTRAN will try to keep the RRC connection and will not force the UE to the idle mode for conveniently using packet-switching service, such as push e-mail, thereby the UE cannot be expected to clear the variable RB_TIMER_INDICATOR by entering the idle mode in a short time. As a result, when the UE in which the timer T314/T315 has been expired performs a cell update procedure again, the RNC of UTRAN will consider the IE “T314 expired”/“T315 expired” TRUE via the received CELL UPDATE message. In this situation, if the implementation of the RNC includes any function associated with the received IE “T314 expired”/“T315 expired”, unpredictable operations may happen and transmission efficiency of the 3G mobile telecommunications system may be reduced.

Moreover, if the UTRAN receives the CELL UPDATE message with TRUE value in the IE “T314 expired”/“T315 expired”, that means, radio bearers associated with the timer T314/T315 shall be released, and as a result, the UTRAN may conclude that current established radio access bearer is inconsistent with the UE and may have incorrect CELL UPDATE CONFIRM message response.

### SUMMARY OF THE INVENTION

The present invention provides a method and related apparatus for improving reset mechanism of radio link re-establishment timers in a wireless communications system.

The present invention discloses a method of improving reset mechanism of radio link re-establishment timers for a UE in a wireless communications system. The method includes performing a cell update procedure according to a radio link failure event, stopping a plurality of re-establishment timers after responding to a CELL UPDATE CONFIRM message, and clearing a variable including the expiration states of the plurality of re-establishment timers.

The present invention further discloses a communications device of a wireless communications system utilized for improving reset mechanism of radio link re-establishment timers. The communications device includes a control circuit for realizing functions of the communications device, a central processing unit installed in the control circuit for executing a program code to operate the control circuit, and a memory coupled to the central processing unit for storing the program code. The program code includes performing a cell update procedure according to a radio link failure event, stopping a plurality of re-establishment timers after responding to a CELL UPDATE CONFIRM message, and clearing a variable including the expiration states of the plurality of re-establishment timers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a communications device.

FIG. 2 is a diagram of the program code shown in FIG. 1.

FIG. 3 is a flowchart of a process according to an embodiment of the present invention.

FIG. 4 is a schematic diagram of a wireless communications system.

### DETAILED DESCRIPTION

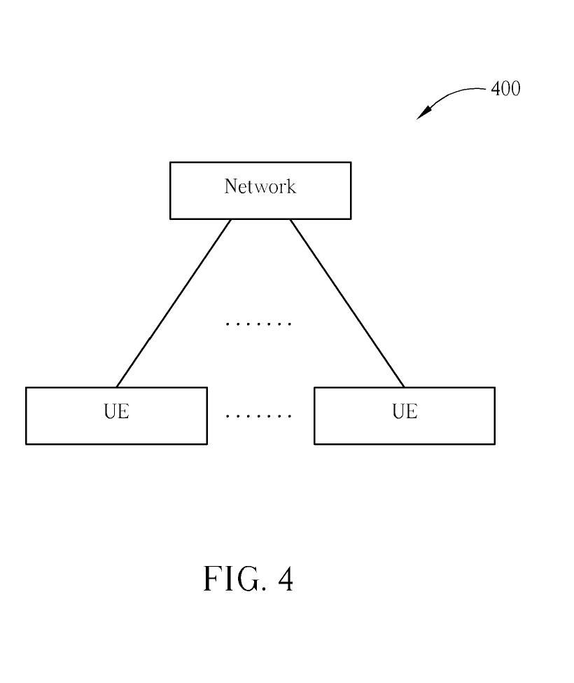

Please refer to FIG. 4, which illustrates a schematic diagram of a wireless communications system 400. The wireless communications system 400 is preferably a High Speed Package Access (HSPA) system, and is briefly composed of a network and a plurality of user equipments (UEs). In FIG. 4, the network and the UEs are simply utilized for illustrating the structure of the wireless communications system 400. Practically, the network terminal may comprise a plurality of base stations (or Node B), radio network controllers and so on according to actual demands, and the UEs can be devices such as mobile phones, computer systems, etc.

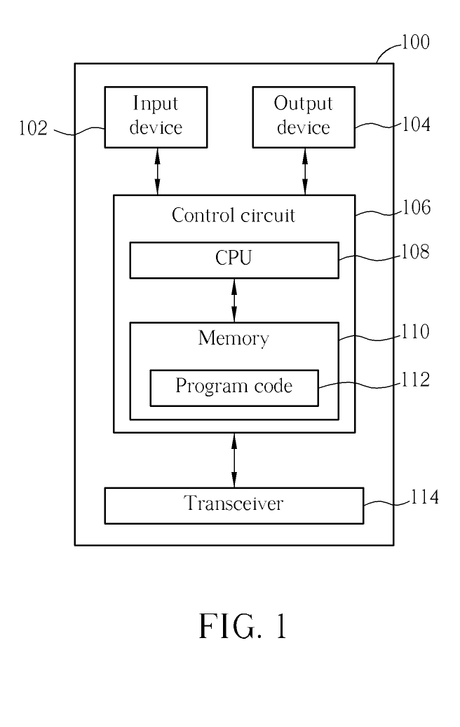

Please refer to FIG. 1, which is a functional block diagram of a communications device 100. The communications device 100 can be used for implementing the network or the UE in the wireless communications system 400 shown in FIG. 4. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

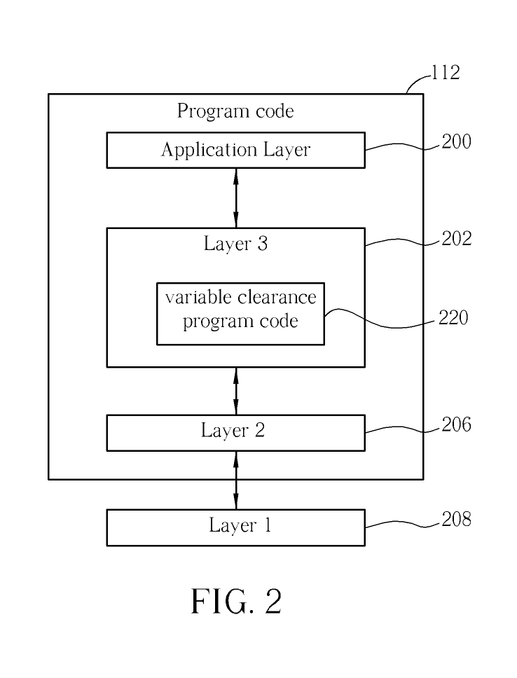

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 208. The Layer 3 202 is for performing radio resource control (RRC). The Layer 2 206 is for performing link control, and the Layer 1 208 is physical layer.

In the prior art, when a radio link failure occurs in a UE during performing some application services in CELL_DCH state, a timer T314/T315 will be started and can be expired while performing a cell update procedure. After the UE responds to a CELL UPDATE CONFIRM Message, an information element (IE) “T314 expired” and an IE “T315 expired” in a variable RB_TIMER_INDICATOR are not cleared if the UE is kept in connected mode. The IE “T314 expired” and the IE “T315 expired” respectively represent the expiration states of the timer T314 and the timer T315. Thereby, when the UE performs the cell update procedure again, the RNC of UTRAN will consider the IE “T314 expired”/“T315 expired” TRUE via the received CELL UPDATE message.

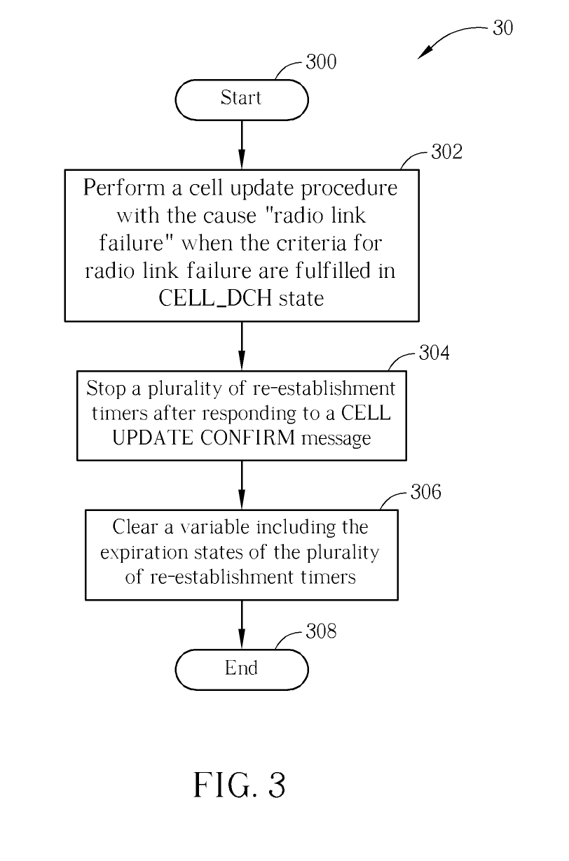

In this situation, the present invention provides a variable clearance program code 220 in the Layer 3 202 to clear the variable RB_TIMER_INDICATOR for improving reset mechanism of radio link re-establishment timers, the timer T314 and the timer T315, so as to prevent the UTRAN from unpredictable operations caused by incorrect received IE “T314 expired”/“T315 expired”. Please refer to FIG. 3, which illustrates a schematic diagram of a process 30 according to an embodiment of the present invention. The process 30 is utilized for improving reset mechanism of radio link re-establishment timers for a UE in the wireless communications system 400. The process 30 can be compiled into the variable clearance program code 220. The process 30 includes the following steps:

Step 300: Start.

Step 302: Perform a cell update procedure with the cause “radio link failure” when the criteria for radio link failure are fulfilled in CELL_DCH state.

Step 304: Stop a plurality of re-establishment timers after responding to a CELL UPDATE CONFIRM message.

Step 306: Clear a variable including the expiration states of the plurality of re-establishment timers.

Step 308: End.

According to the process 30, the last actions a UE does after responding to a CELL UPDATE CONFIRM message can be modified to two actions as follows:

1. Stop the timer T314/T315 if they are running.

2. Clear the variable RB_TIMER_INDICATOR.

As a result, after the UE responds to the CELL UPDATE CONFIRM message and stops the timer T314 and the timer T315, the variable RB_TIMER_INDICATOR is cleared. That is, the IE “T314 expired” and the IE “T315 expired” are set to FALSE. Thereby, when the UE performs the cell update procedure again, the UTRAN will receive the IE “T314 expired”/“T315 expired” with FALSE value, not TRUE, via the CELL UPDATE message.

According to the embodiment of the present invention, the UE in the wireless communications system improves the reset mechanism of radio link re-establishment timers. As a result, even if the system of the UTRAN includes any function associated with the received TRUE value of IE “T314 expired”/“T315 expired”, the UE can prevent unpredictable operations or receiving an incorrect CELL UPDATE CONFIRM message from the UTRAN, so as to enhance transmission efficiency.

Those skilled in the art will readily observe that numerous modifications and alterations of the device and method may be made while retaining the teachings of the invention.

What is claimed is:

1. A method for improving reset mechanism of radio link re-establishment timers for a user equipment in a wireless communications system comprising:
performing a cell update procedure according to a radio link failure event;
stopping a plurality of re-establishment timers after responding to a CELL UPDATE CONFIRM message; and
clearing a variable including the expiration states of the plurality of re-establishment timers.

2. The method of claim 1, wherein the plurality of re-establishment timers are started when the radio link failure event occurs.

3. The method of claim 1, wherein the plurality of re-establishment timers are stopped when the cell update procedure is completed.

4. A communications device of a wireless communications system utilized for improving reset mechanism of radio link re-establishment timers, the communications device comprising:
a control circuit for realizing functions of the communications device;
a central processing unit installed in the control circuit for executing a program code to operate the control circuit; and
a memory coupled to the central processing unit for storing the program code;
wherein the program code comprises:
performing a cell update procedure according to a radio link failure event;
stopping a plurality of re-establishment timers after responding to a CELL UPDATE CONFIRM message; and
clearing a variable including the expiration states of the plurality of re-establishment timers.

5. The communications device of claim 4, wherein the plurality of re-establishment timers are started when the radio link failure event occurs.

6. The communications device of claim 4, wherein the plurality of re-establishment timers are stopped when the cell update procedure is completed.
